(19) United States
(12) Patent Application Publication
(10) Pub. No.: US 2014/0099810 A1
(43) Pub. Date: Apr. 10, 2014

(54) Solar system wiring connectors and methods for secured connection of wiring in an outdoor environment

(71) Applicant: Kenneth Scott, Sunnyvale, CA (US)

(72) Inventor: Kenneth Scott, Sunnyvale, CA (US)

(73) Assignee: Eco Power Design LLC, Sunnyvale, CA (US)

(21) Appl. No.: 13/987,675

(22) Filed: Aug. 21, 2013

Related U.S. Application Data
(60) Provisional application No. 61/743,065, filed on Aug. 27, 2012.

(51) Int. Cl. H01R 13/52; H01R 43/26

(52) U.S. Cl. CPC H01R 13/52; H01R 43/26
USPC 439/183; 29/825

(57) ABSTRACT

The present invention provides long-lasting, reusable wire electrical cable connectors that can be quickly connected and disconnected to accommodate the safe connection or termination of a plurality of wires upon reversibly joining said wire electrical cable connectors, wherein each reusable wire electrical cable connector comprises at least two main members as a connector pair, a male connector member and a female connector member. In a second embodiment type, the invention provides for terminating connector pairs where the male for female connector member is adapted to terminate wiring of a single cable rather than to connect two different cable pairs of the wiring. The invention further provides optional tools for quick connecting and disconnecting of the two connector members of a connector pair of either of the two embodiment types to efficiently snap apart the two connector members for repair or maintenance. In a preferred aspect the invention provides double-sleeving weather sealed protection for the wiring contacts that are held within the connector pair.

### TECHNICAL FIELD

The present invention relates to wiring and connections for outdoor electronics. More particularly, the invention provides wiring, connections and connectors that are utilized in solar power generation systems and the like that must be protected from the environment in order to avoid or minimize damage from rain, dust, UV or corrosive airborne impurities.

### BACKGROUND OF THE INVENTION

Connectors for wiring of outdoor electronics, such as those utilized in solar power generation systems and the like, are expensive and need improvement. They must be sufficient to protect such systems from rain, dust or air and need to be low cost and easy to assemble while providing adequate protection of the wiring and its connections from the environment. Outdoor electrical connectors must meet safety requirements to avoid hazards to workers who are assembling or maintaining these systems, and must be capable of being safety agency approved. Ideally connectors are long-lasting in order to avoid the frequency of expensive maintenance and costs from system down time to repair it. This means that connectors should be able to last at least 25 years in an outdoor environment while providing a good UV rating, being waterproof, having only negligible fretting corrosion and being able to withstand a wide range of temperatures, operating conditions and weather.

When connectors are used to assemble components of a power generations system, such as a solar power generation system, the connectors should have high current capability to allow stringing together of components in a wiring design that raises current to a high current level. Due to heat of components, of wiring or in the surrounding environment, connectors should have a good flammability rating to reduce the risk of fires or to protect the system in the event of fires. Having a high creepage distance between pins in AC connectors can minimize the chance of arcing between pins of connectors.

Connectors for systems described above need to provide protection against an electrical shock hazard. Ways to do so are: (i) multi-pole high voltage rating, (ii) locking mechanisms that are not easily separated or are one time connectors, (iii) having end caps to safely terminate a string of wired components, (iv) recessed pins to meet UL safety requirements, (v) having mechanical shock resistant, especially being not brittle at low temperatures, (vi) keyed to ensure against or reduce the chances that ground pin circuits and other pins' circuits do not get crossed during assembly or repair, and (vii) optionally sufficiently small diameter to fit within electrical conduit (or other electrical housing) to meet national electrical code (NEC) standards.

Prior conventional connectors and string terminator connectors, such as those of Enphase Energy at www.enphase.com, for example, are expensive and lack many of needed features such as those described above.

There is a need for improved wiring connectors and terminator connectors having the above features including operability, durability and safety while being of lower or reduced cost than conventional connectors. Particularly desirable are connectors that can be assembled in the field, can allow for different cable length, can serve as connectors for different diameter cables, and can be disconnected and safely used again with a special tool. While existing outdoor electronics protection connectors and methods can help to protect wiring and electronic components from some environment damages, they all have shortcomings with respect to necessary overall protection, cost or both. Accordingly, there is a need for improved wiring connectors and wiring terminators and methods that provide enhanced protection of outdoor wiring connections and terminations for power generation electronic components, and the like, such as those wiring systems and components that must be used with solar panels and their associated systems.

### BRIEF SUMMARY OF THE INVENTION

In one embodiment, the present invention provides long-lasting, reusable wire electrical cable connectors accommodating the safe connection or termination of a plurality of wires upon reversibly joining said wire electrical cable connectors, said each reusable wire electrical cable connector having at least two main members as a connector pair, a male connector member and a female connector member, wherein:

each male and female connector member of a connector pair may receive one or more cables comprising a plurality of wires to be connected inside the male and female connector members providing that when one of the connector pair is utilized as a wiring terminator said connector member comprises an end cap rather than an opening for one or more cables, a plurality of male connector clips located on the male connector member shaped to mate with a plurality of accommodating of clip receptor areas within the female connector member, and upon connecting create isolated mating separation cavities to keep wires separated from arcing, and at least one sealing member located on or with at least one mating surface of the male and female connectors to shield said plurality of separation cavities and internal cable wiring from weather outside the said reusable wire electrical cable connector, and wherein said female connector comprises a plurality of openings for insertion of a tool to facilitate separation of assembled connector pairs or service or reuse.

In a preferred embodiment, a second sealing member is located at the cable insertion opening for each of the male and female members when said opening is present in order to assist in sealing the end of each connector member after the wiring cable is inserted into the connector member.

In another preferred embodiment each connector pair comprises a connection assurance mechanism ensure that matching wires of each connector pair are mated when connector pairs are assembled. For example, the connection assurance mechanism ensures that ground and hot wires are not cross-wired by accident when each connection pair is properly wired prior to connection.

In one embodiment, inner projections on female members of the connecting members pair fit into receptacles of male members to form a double sleeving protective seal for the internal wiring connectors and a weather seal, such as an o-ring is present on a portion of the inner projections of the female members to further seal internal wiring connectors.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a side view of an assembled electrical connector pair embodiment having a male connector portion 1, a female connector portion 2, a first plurality wire cable 3, a second plurality wire cable 4, a weather seal 5, a male clip member portion 6 and a female clip receptacle portion 7.

FIG. 2 is an angular side view of a first terminating connecting embodiment, which is an assembled electrical pair embodiment similar to FIG. 1, excepting that a female connector portion 8 is a wiring terminating connector member having a wiring terminating end cap 9, and a female clip receptacle portion 10. In FIG. 2, male connector portion 1 is the same as for the embodiment shown in FIG. 1, which comprises a first plurality wire cable 3 and a male clip member 6.

FIG. 3 is an angular side view of a second terminating connector embodiment similar in function to the terminating connector embodiment shown in FIG. 2, excepting that in this second terminating connector embodiment the male connector portion 11 of the assembled electrical pair embodiment is a wiring terminating portion instead of the female terminating connector portion 8 that was shown in the first terminating connector embodiment of FIG. 2. In this embodiment male member 1 of the connector pair female member 2 and. FIG. 3 shows the same embodiment as FIG. 1 for female connector portion 2 and a first plurality wire cable 4, which exposes the female clip receptacle opening 12 of female clip receptacle portion 7 into which male clip member 6 has been inserted.

FIG. 4 shows a disassembled view of an electrical connector pair embodiment similar to FIG. 1 where the male connector portion 1 and the female portion 2 are not connected together in order to show greater details of the male clip members 6 features and female clip receptacle portions that permit reversible connection of the electrical wiring connector pair, and further showing optional connection assurance features 14 and 15 that ensure assembled electrical connector pairs are correctly oriented during their connection in order to reduce the likelihood of accidental cross-wiring.

FIG. 5 shows a disassembled exploded detailed view of male connector portion 1 of the FIG. 1 embodiment and its associated first wiring cable 300.

FIG. 6 shows a disassembled exploded detailed cross-sectional view of male connector portion 1 of the FIG. 1 embodiment and its associated first wiring cable 300.

FIG. 7 shows a disassembled exploded detailed view of female connector portion 2 of the FIG. 1 embodiment and its associated second wiring cable 400.

FIG. 8 shows a disassembled detailed cross-sectional view of male connector portion 2 of the FIG. 1 embodiment and its associated second wiring cable 400.

FIG. 9 shows an assembled cross-sectional detailed view of an electrical connector pair embodiment similar to FIG. 1 where the connector pair are not connected.

FIG. 10 shows an assembled cross-sectional detailed view of an electrical connector pair embodiment similar to FIG. 1 where the connector pair are connected together, which focuses upon details of the engaged locking mechanism provided by male clip member portion 6 and female clip member portion 70.

### DETAILED DESCRIPTION OF THE INVENTION

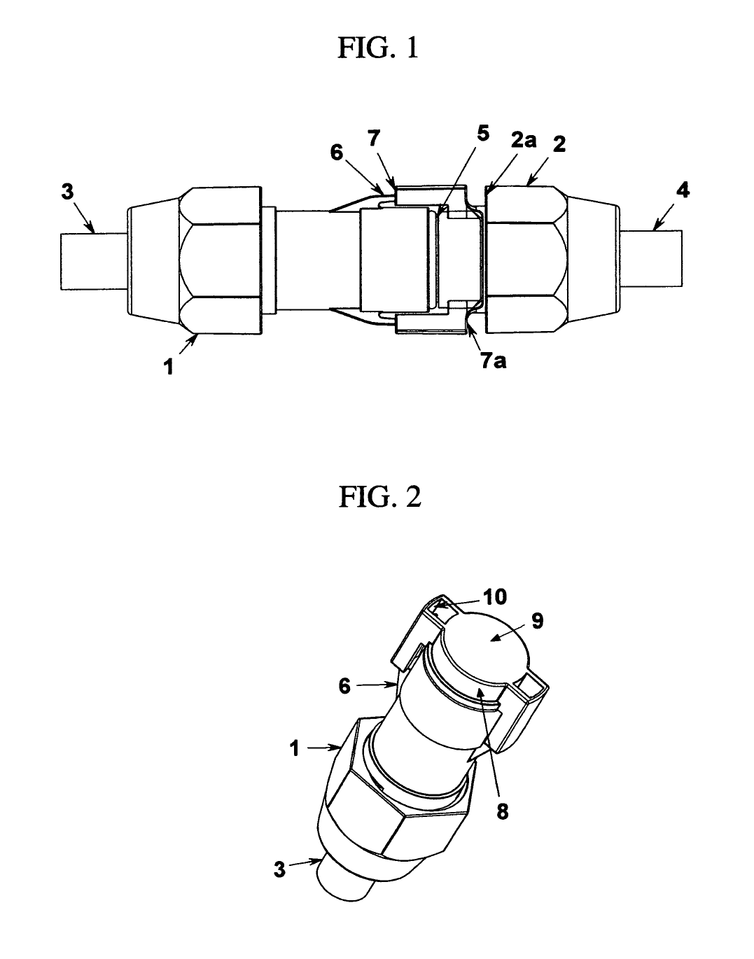

FIG. 1 is a side view of an assembled electrical connector pair embodiment having a male connector portion 1, a female connector portion 2, a first plurality wire cable 3, a second plurality wire cable 4, a weather seal 5, a male clip member portion 6 and a female clip receptacle portion 7. As shown in FIG. 1, an electrical connector pair disassembly tool (not shown) may be inserted into spaces 7a of said female connector portion 2 and optionally wedged against surfaces 2a of said female connector portion 2 to dissemble said assembled electrical connector pair embodiment according to the invention. In a preferred embodiment, said disassembly tool (not shown) anchors against one or more surfaces 2a of said female connector portion 2 and engages a plurality of male clip member portions 6 to efficiently and easily snap loose a plurality of male clip members 6 and female clip receptacle portions 7 to dissemble said assembled electrical connector pair. Further details and cross-sectional views of portions of said electrical connector pair embodiment of FIG. 1 and its terminating embodiment variations are shown in FIGS. 2-10, as described below.

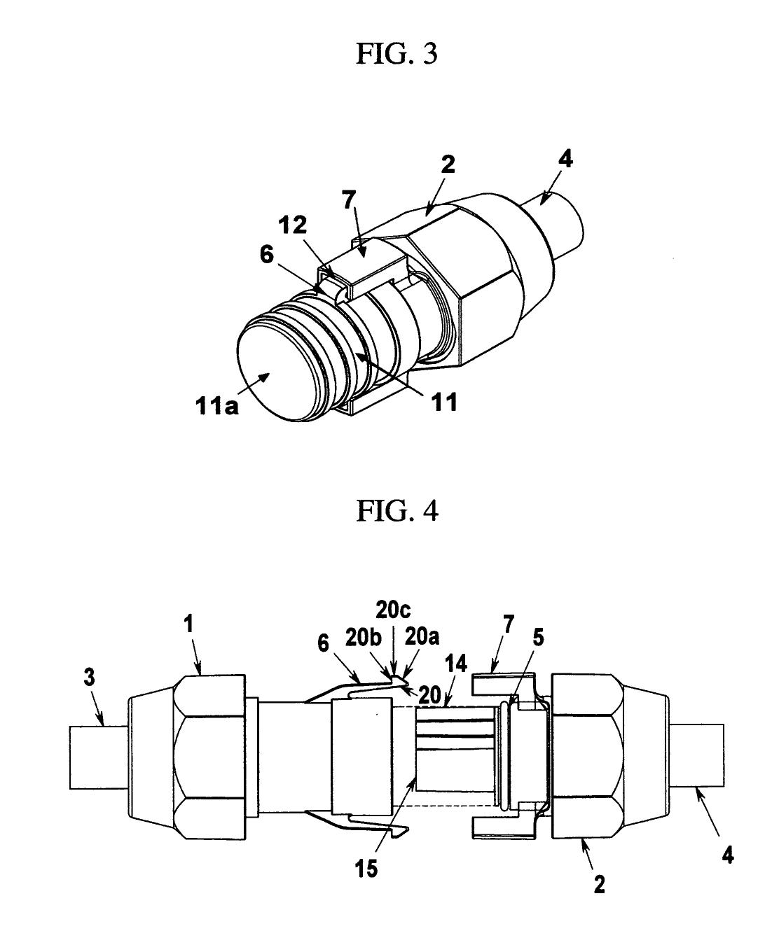

The invention provides connector pairs that connect two wiring cables having one or more insulated wires as wiring members, and also provides for connector pairs that terminate wiring as terminal connectors. Such terminal connector pairs are shown in FIGS. 2 and 3 as angular side views wherein the terminating connecter pair embodiment is in most respects similar to FIG. 1, except that the female connector portion 8 (FIG. 2) or the male connector portion 11 (FIG. 3) each provides a wiring terminating connector member instead of female connector portion 2 or the wiring male connector portion 1 as shown in FIG. 1.

In FIG. 2, a first terminating connector embodiment, shows a female connector portion 8 (wiring terminating connecting member) comprising a wiring terminating end cap 9 and a female clip receptacle portion 10. However, male connector portion 1 of this first terminating embodiment is the same as for the embodiment shown in FIG. 1 and comprises a first plurality wire cable 3 and a male clip member 6. In this embodiment only the female connector portion has different structures. In such a terminating embodiment a special disassembly tool may be utilized (not shown) to engage one or more portions of one or more male clip member portions 6 for quick and efficient disassembly, or a regular mechanic's tool (such as a screwdriver or pliers) end may be inserted to disengage a portion of one or more male clip member portions 6. In a preferred embodiment, a loop or one or more other attachment surfaces (not shown) may be located on wiring terminating end cap 9 under which or through which a disassembly tool (not shown) may be engaged to provide for quick and efficient disassembly of said first terminating connector embodiment.

In FIG. 3, a second terminating connector embodiment shown, is an assembled terminating connector embodiment with a similar function to the terminating connector embodiment shown in FIG. 2, excepting that in this embodiment the male connector portion of the assembled electrical pair embodiment is a wiring terminating portion 11 instead of the terminating portion being said female terminating connector portion 8 as shown in the first terminating connector embodiment of FIG. 2. Said male connector terminating portion 11, comprises a male clip portion 6 and a wiring terminating end cap 11a. FIG. 3 shows the same embodiment as FIG. 1 for female connector portion 2 and a first plurality wire cable 4, and this drawing exposes clearly the female clip receptacle opening 12 for female clip receptacle portion 7 into which male clip member 6 has been inserted when the pair is attached.

In this second terminating connector embodiment shown in FIG. 3 said wiring terminating end cap 11a may further comprise a structure (not shown) for ease of the assembly/disassembly of this connector embodiment, which structure can be in the form of a loop, hook or other type attachment through which or under which a tool can be wedged to snap apart an assembled male/female pair of this embodiment during disassembly of this terminating electrical connector pair embodiment for servicing or repair.

FIG. 4 shows a disassembled side view of an electrical connector pair embodiment similar to FIG. 1 where the male connector portion 1 and the female portion 2 are not connected together in order to show greater details of the male clip members 6 features and female clip receptacle portions 7 that permit reversible connection and disconnection of the electrical wiring connector pair by quick assembly and disassembly. End portions of male clip members 6 of said male connector portion 1 collectively form a connection lug 20, having a substantially pointed angular leading edge 20a, an optional flatter axis external edge substantially longitudinal to the axis of said male connector portion 1 and having a locking edge 20b that is substantially perpendicular to the longitudinal axis of said male connector portion 1. The lugs 20 of male clip member portions 6 slide through openings in female clip receptacle portions 7 and are said lugs are compressed spring-like in the opposite direction of surface 20c until locking edge 20b of lug 20 articulates with a portion of female clip portions 7 as depressed lug 20 springs back in an outward direction along a locking edge (not shown) of female clip receptacle portions 7 to reversibly assemble said electrical connector pair.

This FIG. 4 dissembled side view of the FIG. 1 embodiment further shows optional connection assurance features 14 and 15 that can be designed to limit engagement of pairs of male and female portions a particular electrical pair for an electrical system to help ensure that particular assembled electrical connector pairs are correctly oriented during their connection in order to reduce likelihood of accidental cross-wiring. Different shapes and dimensions for optional assurance features 14 and 15 may be varied in any manner desired to produce mating pairs of male and female portions for particular electrical connector pairs, which can be assembled easily and correctly oriented with minimal understand of wiring schematics and electrical systems. Such features are ideal for electrical connection “kits” where cables and connector pairs are pre-fabricated for site assemble and can be designed with different connection assurance features to facility correct assemble.

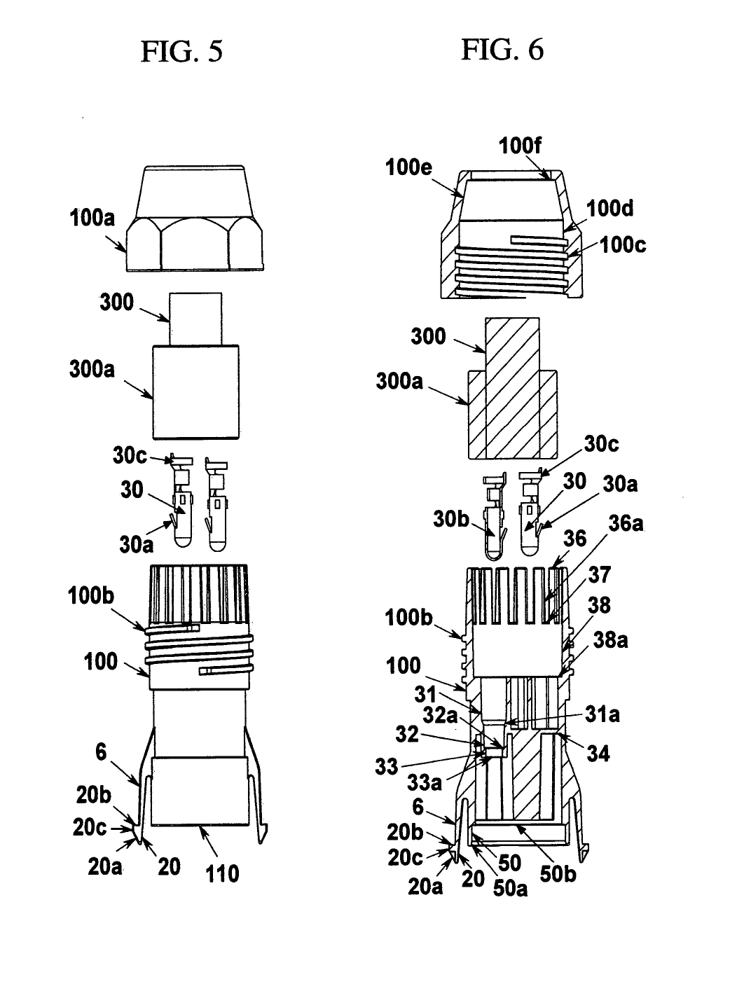

The male connector portion of FIG. 4 is dissembled further to provide a detailed side view of the FIG. 1 embodiment as shown in a disassembled exploded detailed view FIG. 5 along with associated wiring cable and details for “molex-like” male connector pins.

FIG. 5 shows a male connector portion main body 100 embodiment and a male connector portion cylindrical assembly nut 100a (shown as a hex shaped nut) through which a hollow middle (not shown, see hollow middle 100f in the cross-section view in FIG. 6) of said cylindrical assemble nut 100a permits passing (shown in FIG. 6 exploded disassembled cross-sectional view) a wiring cable 300 that has a cylindrical sleeve cable shield 300a placed over it as a spacer to fit within the hollow middle 100f portion of cylindrical assembly nut 100a. Also shown are empty (by empty, meaning shown as an exploded view rather than attached to said wiring cable 300 wires) two “molex-like” crimp male pin type electrical connector contacts 30, having a connector crimp contact shape similar to but different from Jameco molex crimp male pin connector part number 224565 (see www.jameco.com). While such contacts are referenced against classical molex crimp connectors, the reference is more to illustrate the differences between theses contacts and classic molex connector contacts as these contacts are NOT molex connectors. However, molex connectors could be utilized in the present invention by modifying and adapting the internal structures of the connector pairs to accommodate molex connectors within each of the male/female connector portion's main body. As illustrated by cross-sectional views of the “molex-like” said crimp male pin type electrical connector contact 30 embodiment, this embodiment only shows one pin placement lock tab 30a and one wire securing crimp band 30c, which are used instead of molex connectors that have two tabs and two bands as shown in referenced sample Jameco molex pin connector catalog part. Thickness gauge for pin walls and metallic materials of “molex-like” said crimp male pin type electrical connector contact 30 can be varied depending upon the desired voltage and amperage that will need to be conducted by the pin type electrical connector contact part of this connector. How to prepare a wire for “molex-like” crimp pin and how to crimp a wire into a “molex-like” crimp portion are well-known to electrical technicians and do not require further discussion or illustration.

FIG. 5 shows additional details for said male connector portion main body 100 embodiment. Male screw surfaces 100b are cut into or molded on male connector portion main body 100 that can mate with male connector portion cylindrical assembly nut 100a to screw into female thread surfaces (not shown in FIG. 5, but see female thread surfaces 100c of FIG. 6). Male connector portion main body 100 has an opening 110 for connecting to one or more portions of a female connector portion. The electrical connector pair are held in place (in part) by end portions of male clip members 6 of male connector portion main body 100 that collectively form connection lugs 20, having a substantially pointed angular leading edge 20a, an optional flatter axis external edge 20c substantially longitudinal to the axis of said male connector main body 100 and having a locking edge 20b that is substantially perpendicular to the longitudinal axis of said male connector main body 100.

FIG. 6 shows a disassembled exploded detailed cross-sectional view of male connector portion 1 of the FIG. 1 embodiment and its associated first wiring cable 300. These cross-sectional details correspond to structures and features that are shown in disassembled exploded views of FIG. 5 as described above. FIG. 6 shows a cross sectional view for male connector portion 100a (shown as a hex shaped nut) and a cross-sectional view of said male connector portion main body 100 embodiment. Cylindrical assembly nut 100d includes a hollow middle 100f feature that permits passing through a wiring cable 300 (shown exploded rather than assembled) that has a cylindrical sleeve cable shield 300a placed over it as a spacer to fit within the hollow middle 100f portion of cylindrical assembly nut 100d. Female threads 100c are located within cylindrical assembly nut 100d to mate with male threads 100b located on male connector main body 100 to cause a slanted or tapered surface 100e of male connector portion 100a to force spline teeth 36 located on of male connector main body 100 to be depressed and assist in holding wiring cable 300 (not shown assembled) or assist in holding in place within and male connector main body 100 when they are assembled. “Molex like” crimp male pin type electrical connector contact 30 features and details are described above with respect to FIG. 5, and are repeated here by reference. FIG. 6 shows a further cross-sectional view for “molex-like” crimp male pin type electrical connector contact 30 as a “molex-like” male pin type electrical connector cross sectional view 30b. Cable wiring can be assembled within either of the “molex-like” crimp male pin type electrical connector contact 30 or “molex-like” crimp male pin type electrical connector cross sectional view 30b. Techniques and procedures for preparing cable wires to install within “molex-like” crimp pins and crimping such cable wires in place within “molex-like” crimp pins are well-known to electrical technicians.

In addition to structures and features that are described above for disassembled exploded views of in the descriptions for FIG. 5, FIG. 6 has additional structures and features for male connector main body 100. A plurality of compressible tooth splines 36 having a plurality of longitudinal surfaces 36a that are separated by spline spaces 37 are located on male connector main body 100 to permit compressible movement of tooth splines 36 to grip and hold it and its central wiring cable 300 in place within cylindrical assembly nut 100d when assembled as described generally above. Male connector main body 100 shows body side walls 38 and stop surfaces 38a that collectively form a cavity for further anchoring cylindrical sleeve cable shield 300a in place when assembled and compressed by tooth splines 36. Male connector main body 100 also includes accommodating cavities and features for holding and securing “molex-like” crimp male pin type electrical connector contacts 30 in place when assembled with wiring cables and installed within male connector main body 100. Male pin insulated wire cavity 31 partially terminates with a surface 31a and a smaller diameter cavity continues on through male connector main body 100 and terminates with transverse surface on portion 33 for anchoring male pin placement lock tab 30a (described above) as male pin anchoring surface 32a within a larger male/female pin connector cavity 34 that can accept a cylindrical or other connection assurance shaped projection from a matching female wiring connector portion of an electrical wiring connector pair when assembled. Male clip members 6 of male connector portion main body 100 are described above in the discussion of FIG. 5 and those details and features are incorporated for FIG. 6 by reference. Male connector main body 100 also shows a weather seal (such as an o-ring) trough or groove 50 that has a weather seal leading edge lip 50a and a weather seal anchoring edge 50b located substantially perpendicular to the longitudinal axis of said male connector main body 100.

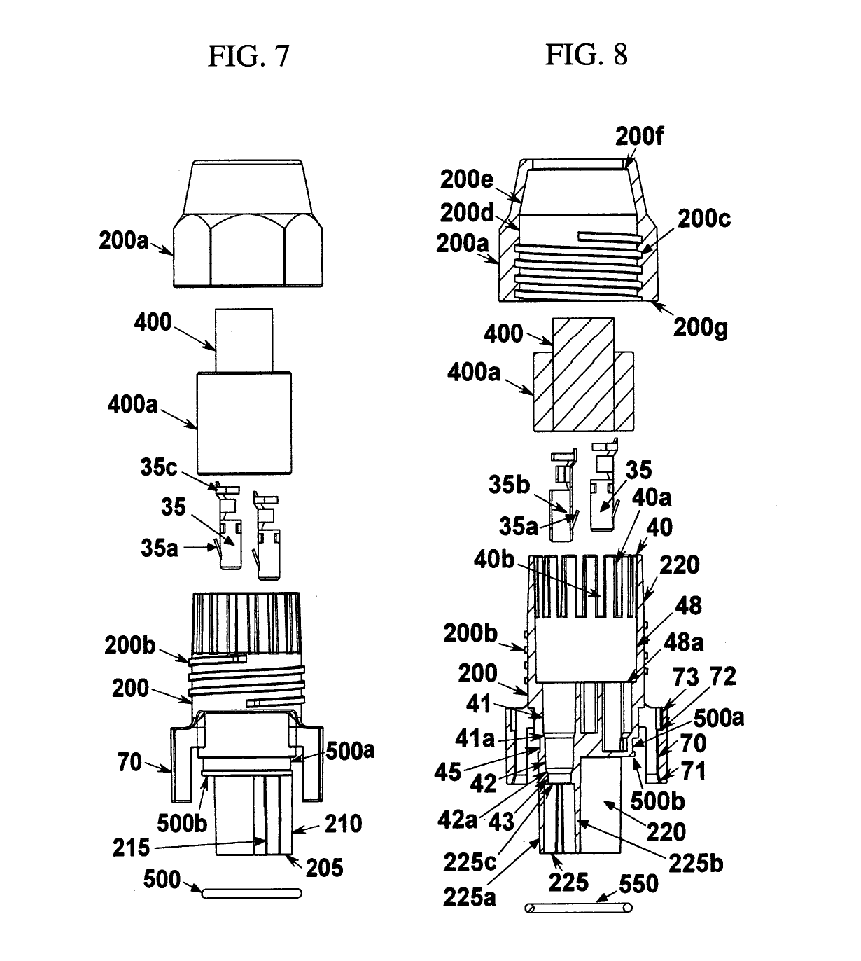

FIG. 7 shows a female connector portion main body 200 embodiment and a female connector portion cylindrical assembly nut 200a (shown as a hex shaped nut) through which a hollow middle (not shown, see hollow middle 200f in a cross-section view of FIG. 8) of said cylindrical assemble nut 200a permits passing (shown in FIG. 8 exploded disassembled cross-sectional view) a wiring cable 400 that has a cylindrical sleeve cable shield 400a placed over it as a spacer to fit within the hollow middle 200f portion of cylindrical assembly nut 200a. Also shown are empty (by empty, meaning shown as an exploded view rather than attached to said wiring cable 400 wires) two “molex-like” crimp female pin type electrical connector contacts 35, having a connector contact shape somewhat similar but different as contrasted with Jameco molex style crimp female pin connector part number 224557 (see www.jameco.com). However, as illustrated by cross-sectional views of “molex-like” said crimp female pin type electrical connector contact 35 embodiment, this embodiment only shows one pin placement lock tab 35a and one wire securing crimp band 35c instead of the classic molex two tabs and two bands as shown for the referenced sample Jameco molex pin connector catalog part. While the electrical wiring connectors according to the invention may be modified to accommodate molex adaptors, the current shapes and structures provide an easy connect/disconnect while providing adequate securing in place of the contacts. Thickness gauge for pin walls and metallic materials of “molex-like” crimp female pin type electrical connector contact 35 can be varied depending upon the desired voltage and amperage to be conducted by the pin type electrical connector contact part. How to prepare a wire for “molex-like” crimp pin and to crimp a wire into a female “molex-like” crimp are well-known to electrical technicians that can be conceptually applied to the present wiring contacts and do not require further discussion or illustration.

FIG. 7 shows additional details for said female connector portion main body 200 embodiment. Male screw surfaces 200b are cut into or molded on female connector portion main body 200 that can mate with female connector portion cylindrical assembly nut 200a to screw into female thread surfaces (not shown in FIG. 7, but see female thread surfaces 200c of FIG. 8). Female connector portion main body 200 has a connection assurance portion 205 with shaping of connection assurance portions 210 and 215 (may include other shapes) to assure proper connection of said female connector portion main body 200 with a matching male connector portion main body 100 to collectively form a matching electrical wiring connector pair with properly oriented pass through connection of wiring. The matching electrical wiring connector pair are held in place (in part) by end portions of male clip members 6 of male connector portion main body 100 (see FIG. 5) that are inserted within female clip receptacle portions 70 (see FIG. 7) that permit reversible connection and disconnection of the electrical wiring connector pair by quick assembly and disassembly. FIG. 7 also shows an independent uninstalled weather seal (such as an o-ring) 500 and shows on female connector main body 200 a receiving area weather seal trough or groove 500a to receive weather seal (such as an o-ring) 500. A weather seal lip 500b is also located substantially perpendicular to the longitudinal axis of said female connector main body 200 to help anchor the weather seal 500 in place on female connector main body 200.

FIG. 8 shows a disassembled exploded detailed cross-sectional view of female connector portion 2 of the FIG. 1 embodiment and its associated second wiring cable 400. These cross-sectional details correspond to structures and features shown in disassembled exploded views of FIG. 7, as described above. FIG. 8 shows a cross sectional view for female connector portion 200a (shown as a hex shaped nut) and a cross-sectional view of said male connector portion main body 200 embodiment. Cylindrical assembly nut 200d includes a hollow middle 200f feature that permits passing through a wiring cable 400 (shown exploded rather than assembled) that has a cylindrical sleeve cable shield 400a placed over it as a spacer to fit within the hollow middle 200f portion of cylindrical assembly nut 200d. Female threads 200c are located within cylindrical assembly nut 200d to mate with male threads 200b located on female connector main body 200 to cause a slanted or tapered surface 200e of female connector portion 200a to force spline teeth 40 located on a portion 220 of female connector main body 200 to be depressed and assist in holding wiring cable 400 (not shown assembled) or assist in holding cylindrical sleeve cable shield 400a in place within female connector main body portion 220 when they are assembled. “Molex-like” crimp female pin type electrical connector contact 35 features and details are described above with respect to FIG. 7, and are repeated here by reference. FIG. 8 shows a further cross-sectional view for “molex-like” crimp female pin type electrical connector contact 35 as a “molex-like” crimp female pin type electrical connector cross sectional view 35b. Cable wiring can be assembled within “molex-like” crimp female pin type electrical connector contact 35 or within “molex-like” crimp female pin type electrical connector cross sectional view 35b. Techniques and procedures for preparing cable wires to install within “molex-like” crimp pins and crimping cable wires in place within female “molex-like” crimp pins are well-known to electrical technicians in this field and these concepts can be applied to the present “molex-like” crimp wiring contact connectors.

In addition to structures and features that are described above for disassembled exploded views of FIG. 7, FIG. 8 has additional structures and features for female connector main body 200. A plurality of compressible tooth splines 40 with a plurality of longitudinal surfaces 40a separated by spline spaces 40b are located on female connector main body 200 in female connector portion 220 to permit compressible movement of tooth splines 40 to grip and hold its central wiring cable 400 in place within cylindrical assembly nut 200d when assembled as described generally above. Female connector main body 200 shows body side walls 48 and stop surfaces 48a that collectively form a cavity for further anchoring cylindrical sleeve cable shield 400a in place when assembled and compressed by tooth splines 40. Female connector main body 200 also includes cavities and features for holding and securing “molex-like” crimp female pin type electrical connector contacts 35 in place when assembled with wiring cables and installed within female connector main body 200. Importantly, these cavities and features may be modified to accommodate classic molex style crimp female contact pins, but the current design permits easy and convenient assembly and disassembly of said wiring contacts from the female connector body 200. Female contact pin insulated wire cavity 41 partially terminates with a surface 41a and a smaller diameter cavity continues on through female connector main body 200 and terminates with a transverse surface for anchoring female pin placement lock tab 35a (described above) as female contact pin anchoring surface 43 within a larger male/female pin connector cavity 225 that comprises cylindrical or other connection assurance shaped projections with portions 225a, 225b and 225c shown in FIG. 8. Female clip receptacle portions 70 (see FIG. 7) for housing male clip member portions 6 permit reversible connection and disconnection of a matching electrical wiring connector pair by quick assembly and disassembly. A cross-sectional view for female clip receptacle portions 70 is shown in FIG. 8 with a female clip receptacle port opening 71, a lug receptacle space 73 and a lug lock surface 72. Cut-away 220 is provided for better viewing of features within female connector main body 200. Female connector main body 200 has a weather seal (such as an o-ring) trough or groove 500a with a weather seal lip 500b and FIG. 8 shows a cross-sectional view of weather seal 550 that is not assembled in female connector main body 200.

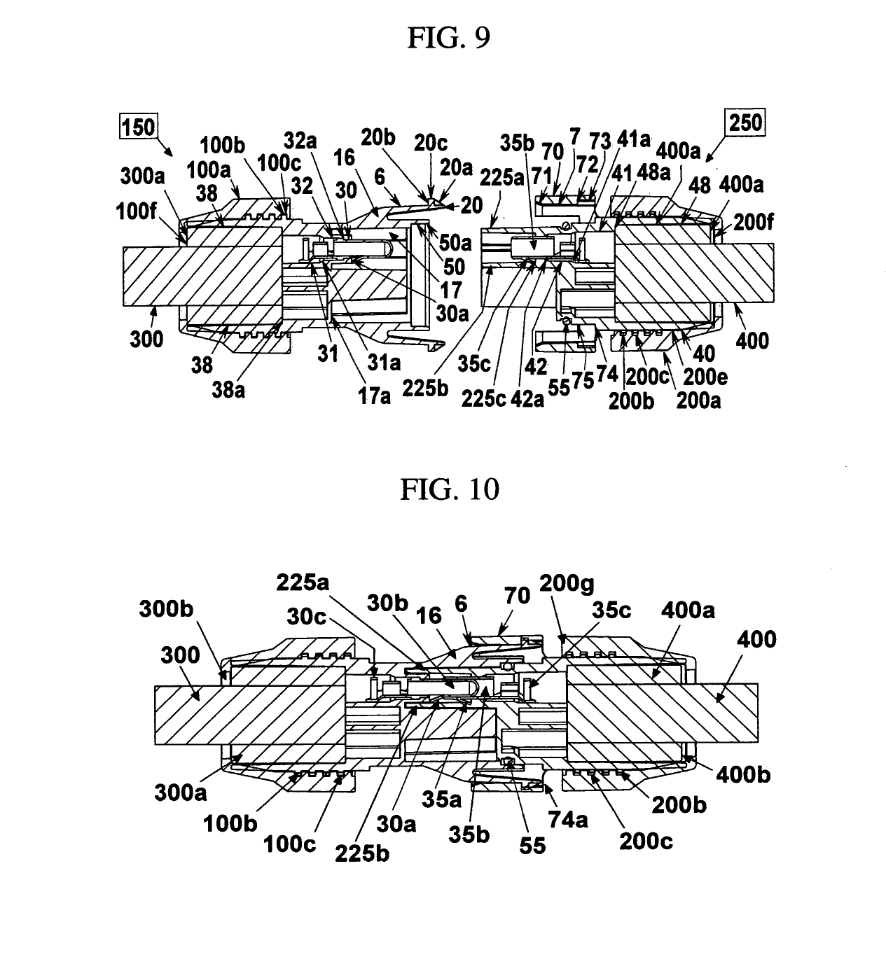

FIG. 9 shows a cross-sectional detailed view for individually assembled male electrical connector portion 150 and female electrical connector portion 250 of an electrical connector pair embodiment similar to the FIG. 1 embodiment where cable wiring has been installed within each of the electrical connector portions but the portions of said connector pair are not yet connected to one another. Structures and features for each of the individually assembled male electrical connector portion 150 and female electrical connector portion 250 in FIG. 9 have the same numbering as for corresponding cross-sectional features shown in FIGS. 6 and 8 or shown in side-view FIGS. 5 and 7, respectively (male and female). Such corresponding structures and features in each of the male and female electrical connector portions of this electrical connector pair embodiment described above for FIGS. 5-8 have the same meanings and descriptions when in FIG. 9 and are incorporated here by reference.

In addition to structures and features that are described above for disassembled exploded cross-sectional views of male connector main body 100 as shown in FIG. 6 or as shown in a side view of FIG. 5, FIG. 9 has additional structures and features that are further shown in male electrical connector portion 150. The cross-sectional assembled male connector portion of FIG. 9 shows a pin placement lock tab 30a of a “molex-like” crimp male pin type electrical connector shown as a cross sectional view 30b locked against a male pin anchoring surface 32a of said male electrical connector main body 100. Also shown are connection assurance cavities 17 having transverse surfaces 17a that can receive connection assurance portions 225a and 225b of female electrical connector portion 250, see further details below in the description of additional female electrical connector portion 250. Once the connection assurance portions 225a and 225b are inserted and mated within this matching portion (connection assurance cavities 17) of said male electrical connector main body 100 they will collectively compress an installed weather seal 55 and can only be mated in a way that causes accurate electrical connection of “molex-like” crimp male pin type electrical connector 30 and “molex-like” crimp female pin type electrical connector 35 that are installed in male electrical connector portion 150 and in female electrical connector portion 250, respectively. Upon mating of male electrical connector portion 150 and female electrical connector portion 250, a portion of male electrical main body 100 indicated numbered in FIG. 9 as main body area 16 provides a double sleeving for the connected “molex-like” crimp male pin type electrical connector 30 and “molex-like” crimp female pin type electrical connector 35 installed within male electrical connector portion 150 and female electrical connector portion 250. Descriptions for the other structures and features of male electrical connector portion 150 may be found in one or more of the above descriptions for FIGS. 5 and 6 and may be further discussed below when describing the installed, assembled electrical connector embodiment pair of FIG. 10.

In addition to structures and features that are described above for disassembled exploded cross-sectional views of female connector main body 200 as shown in FIG. 8 or as shown in its side view FIG. 7, FIG. 9 has additional structures and features that are further shown in female electrical connector portion 250. The cross-sectional assembled female connector portion of FIG. 9 shows a pin placement lock tab 35a of a “molex-like” crimp female pin type electrical connector shown as a cross sectional view 35b locked against a female pin anchoring surface 225c of said female electrical connector main body 200. Connection assurance portions 225a and 225b are shown as protrusions from female electrical connector portion 250 (may be fingers or other shaped structures) that are inserted into male electrical connector portion 150 during installation to mate with its connection assurance cavities 17 that have transverse surfaces 17a. Once the connection assurance portions 225a and 225b are inserted and mated within the matching features portion shown in FIG. 9 as connection assurance cavities 17 of said male electrical connector main body 100 they will collectively compress an installed weather seal 55. Collectively, connection assurance cavities 17 and connection assurance portions 225a and 225b are designed to only be mated in a way that causes accurate electrical connection of “molex-like” crimp male pin type electrical connector 30 and “molex-like” crimp female pin type electrical connector 35, which are each installed within male electrical connector portion 150 and female electrical connector portion 250, respectively.

FIG. 9 also shows female clip receptacle portion 70 with a cross-sectional view of male lug receiving cavity 74 and weather seal lip cavity 75 that receives weather seal lip 50a projection of male electrical connector main body 100 to compress weather seal 55 between mating portions of male electrical connector main body 100 and female electrical connector main body 200 of electrical connector portions 150 and 250, respectively.

Descriptions for the other structures and features of male electrical connector portion 250 are found in one or more of the above descriptions for FIGS. 7 and 8 and may be further discussed below when describing the installed, assembled electrical connector embodiment pair of FIG. 10.

FIG. 10 shows an assembled cross-sectional detailed view of an electrical connector pair embodiment similar to FIG. 1 where said connector pair cross-sectional view portions as shown in FIG. 9 and described above are connected together. Since most of the features and structures shown in FIG. 10 were also present and described for FIG. 9 and are incorporated here by reference, this description focuses upon details of reversibly engaged locking mechanisms and seals that are provided when said electrical pair embodiment are connected together. FIG. 10 shows connected “molex-like” crimp male pin type electrical connector 30a within male electrical connector portion 150 from FIG. 9 and “molex-like” crimp female pin type electrical connector 35a installed within female electrical connector portion 250 from FIG. 9 are reversibly joined together by inserting one end of “molex-like” crimp male pin type electrical connector 30a into one end of “molex-like” crimp female pin type electrical connector 35a when the two portions of said electrical connector pair embodiment are connected together. Upon mating of male electrical connector portion 150 and female electrical connector portion 250 that are shown individually in FIG. 9, main body area 16 (shown in FIG. 10) and the installed and weather sealed connection of protrusions from assurance portions 225a and 225b inserted into connection assurance cavities 17 (not shown in FIG. 10, but shown in FIG. 9) collectively provide a weather-sealed, double-sleeving portion for the installed and connected “molex-like” crimp male pin type electrical connector 30a and “molex-like” crimp female pin type electrical connector 35a “molex-like” crimp electrical contact pair.

FIG. 10 shows an assembled cross-sectional detailed view of an electrical connector pair embodiment similar to FIG. 1 where said connector pair cross-sectional view portions as shown in FIG. 9 and described above are connected together. Since most of the features and structures shown in FIG. 10 were also present and described for FIG. 9 and are incorporated here by reference, this description focuses upon details of reversibly engaged locking mechanisms and seals that are provided when said electrical pair embodiment are connected together. FIG. 10 shows connected “molex-like” crimp male pin type electrical connector 30a within male electrical connector portion 150 from FIG. 9 and “molex-like” crimp female pin type electrical connector 35a installed within female electrical connector portion 250 from FIG. 9 are reversibly joined together by inserting one end of “molex-like” male pin type electrical connector 30a into one end of “molex-like” crimp female pin type electrical connector 35a when the two portions of said electrical connector pair embodiment are connected together. Upon mating of male electrical connector portion 150 and female electrical connector portion 250 that are shown individually in FIG. 9, main body area 16 (shown in FIG. 10) and the installed and weather sealed connection of protrusions from assurance portions 225a and 225b inserted into connection assurance cavities 17 (not shown in FIG. 10, but shown in FIG. 9) collectively provide a weather-sealed, double-sleeving portion for the installed and connected “molex-like” crimp male pin type electrical connector 30a and “molex-like” crimp female pin type electrical connector 35a “molex-like” crimp electrical contact pair.

Reversible mating and disconnecting for service of male electrical connector portion 150 and female electrical connector portion 250 from FIG. 9 to provide a connected pair embodiment of an electrical connector pair according to FIG. 1 shown in cross-sectional detailed view in FIG. 10 are facilitated by easy connection and disconnection of male clip member portion 6 from anchoring female clip member portion area 70. In a preferred embodiment a easy disconnection tool (not shown) comprises a plurality of projections on said tool that can be inserted simultaneously within a plurality of anchoring female clip member portion cavity openings 74a and anchored against surface 200g of at least one female electrical connector portion 250 on the cylindrical assembly nut 200a (labeled in FIG. 9 and shown but not labeled in FIG. 10) of female electrical connector portion 250 from FIG. 9 to dislodge a plurality of male clip member portions 6 that are anchored within a plurality of cavities within anchoring female clip member portion area 70 shown as a lug lock surface 72 and lug receptacle space 73 in FIG. 9.

In one embodiment, the present invention provides long-lasting, reusable wire electrical cable connectors accommodating the safe connection or termination of a plurality of wires upon reversibly joining said wire electrical cable connectors such as the embodiments shown and described in FIGS. 1-10, wherein each reusable wire electrical cable connector comprises at least two main members such as shown in cross-sectional view detail if FIG. 9 or in other cross-sectional or side view of FIGS. 1-8 as a connector pair shown connected in FIGS. 1 and 10, as a male connector member and a female connector member,

wherein each male and female connector member of a connector pair may receive one or more cables comprising a plurality of wires to be connected inside the male and female connector members such as by “molex-like” connectors, providing that when one of the connector pair is utilized as a wiring terminator as shown in FIG. 2 or FIG. 3 said connector member comprises an end cap such as end caps shown as wiring terminating end cap 9 or wiring end cap 11b in FIGS. 2 and 3, respectively, rather than comprising an opening for one or more wiring cables, a plurality of male connector clips located on the male connector member shaped to mate with a plurality of accommodating of clip receptor areas within the female connector member, and upon connecting create isolated mating separation cavities to keep wires separated from arcing, and at least one sealing member located on or with at least one mating surface of the male and female connectors to shield said plurality of separation cavities and internal cable wiring from weather outside the said reusable wire electrical cable connector, and wherein said female connector comprises a plurality of openings for insertion of a tool to facilitate separation of assembled connector pairs or service or reuse.

In one embodiment the invention provides, a durable, long-lasting, reusable electrical wiring cable connector with at least two connectable members as an electrical wiring cable connector pair that can be reversibly joined to provide isolated electrical connections for a plurality of wiring cable groups or termination of at least one wiring cable group within said electrical wiring cable connector pair, said electrical wiring cable connector having at least two main connectable members for said electrical wiring cable connector pair referred to individually as a male connector member and a female connector member, wherein:

said each male and female connector members of said connector pair comprise a means for receiving one or more cables groups comprising a plurality of wires to be connected inside said male and female connector members when assembled providing that when one of the connector pair is utilized as a wiring cable group terminator said connector member comprises at least one end cap rather than an opening for one or more cables groups,

said male connector member comprises a plurality of male connector clips that are located on an outer portion of said male connector member wherein said male connector clips are shaped to mate with a plurality of accommodating clip receptor structure areas located upon or within said female connector member,

upon connecting said male and female connector members said connector pair create a plurality of isolated wiring contact mating separation cavities to keep cable wiring electrically separated in order to prevent or reduce electrical arcing,

said connected connector pair comprising and at least one sealing member located on or within at least one mating surface of said male and female connector members to shield said plurality of separation cavities and said internal contacts for cable wiring from the environment or weather outside of said reusable wiring electrical cable connector, and

said female connector comprises a plurality of accessible openings for insertion of one or more tools to facilitate separation of an assembled connector pair for service or for their reuse.

In a preferred embodiment, a second sealing member is located at the cable insertion opening for each of the male and female members when said opening is present in order to assist in sealing the end of each connector member after the wiring cable is inserted into the connector member.

In another preferred embodiment each connector pair comprises a connection assurance mechanism to ensure that matching wires of each connector pair are mated when connector pairs are assembled. For example, the connection assurance mechanism ensures that ground and hot wires are not cross-wired by accident when each connection pair is properly wired prior to connection.

In one embodiment, inner projections on female members of the connecting members pair fit into receptacles of male members to form a double sleeving protective seal for the internal wiring connectors that preferably use mating male and female specially adapted “molex-like” wiring contacts within as wiring connectors and a weather seal, such as an o-ring is present on a portion of the inner projections of the female members to further seal internal wiring contacts of said connectors.

The a second embodiment type the invention provides connector pairs that terminate wiring for a wiring cable having one or more insulated wires as wiring members to provide electrical connector terminating pairs. Such terminal connector pairs are similar in structure to the first type of embodiment shown in FIG. 1 excepting that the terminating connecter pair embodiment comprises a terminating female connector portion 8 (FIG. 2) or a terminating male connector portion 11 (FIG. 3) as a wiring terminating connector member instead of female connector portion 2 or the wiring male connector portion 1 as shown in FIG. 1, which permitted two cables to be connected rather than a single cable to be terminated.

The first terminating connector embodiment provided by the invention shows a female connector portion (wiring terminating connecting member) comprising a wiring terminating end cap and a female clip receptacle portion. However, the male connector portion of this first terminating embodiment pair is the same as for the two cable wiring connection embodiment and comprises a first plurality wire cable and a male clip member. In this embodiment only the female connector portion has different structures that the first type two cable wiring connection embodiment. In such a terminating embodiment a special disassembly tool may be utilized (not shown) to engage one or more portions of one or more male clip member portions or quick and efficient disassembly, or a regular mechanic's tool (such as a screwdriver or pliers) end may be inserted to disengage a portion of one or more male clip member portions. In a preferred embodiment, a loop or one or more other attachment surfaces (not shown) may be located on wiring terminating end cap under which or through which a disassembly tool (not shown) may be engaged to provide for quick and efficient disassembly of said first terminating connector embodiment.

The second terminating connector embodiment provided by the invention is an assembled terminating connector embodiment with a similar function to the first terminating connector embodiment described above that terminates a wiring cable, excepting that in this embodiment the male connector portion of the assembled electrical pair embodiment is a wiring terminating portion instead of the terminating portion being said female terminating connector portion as described above for the first terminating connector embodiment. The male connector terminating portion comprises a male clip portion and a wiring terminating end cap. In this second wiring terminating connector pair the female connector portion and a second plurality wire cable are the same as for the two cables wiring connector embodiment. The female connector portion has a female clip receptacle opening 12 as a structure of female clip receptacle portion 7 into which male clip member 6 of the terminating portion 11 has been inserted when the pair is attached.

Other aspects and advantages of the present invention will become apparent from the following detailed description, taken in conjunction with the accompanying drawings, illustrated by way of example of the principles of the invention. The scope of the invention is to be defined by the claims appended hereto and their equivalents.

What is claimed is:

1. A durable, long-lasting, reusable electrical wiring cable connector having at least two connectable members as an electrical wiring cable connector pair that can be reversibly joined to provide isolated electrical connections for a plurality of wiring cable groups or for termination of at least one wiring cable group within said electrical wiring cable connector pair, said electrical wiring cable connector having at least two main connectable members as an electrical wiring cable connector pair that may be referred to individually as a male connector member and a female connector member, wherein:
said each male and female connector members of said connector pair comprise a means for receiving one or more cables groups comprising a plurality of wires to be connected inside said male and female connector members when assembled providing that when one of the connector pair is utilized as a wiring cable group terminator said connector member comprises at least one end cap rather than an opening for one or more cables groups,
said male connector member comprises a plurality of male connector clips that are located on an outer portion of said male connector member wherein said male connector clips are shaped to mate with a plurality of accommodating clip receptor structure areas located upon or within said female connector member,
upon connecting said male and female connector members said connector pair create a plurality of isolated wiring contact mating separation cavities to keep cable wiring electrically separated in order to prevent or reduce electrical arcing,
said connected connector pair comprising and at least one sealing member located on or within at least one mating surface of said male and female connector members to shield said plurality of separation cavities and said internal contacts for cable wiring from the environment or weather outside of said reusable wiring electrical cable connector, and
said female connector comprises a plurality of accessible openings for insertion of one or more tools to facilitate separation of an assembled connector pair for service or for reuse.

2. The electrical wiring cable connector of claim 1, wherein said electrical wiring cable connector is small enough to fit within electrical conduit.

3. The electrical wiring cable connector of claim 2, wherein said electrical wiring cable connector is small enough to fit within small electrical conduit.

4. The electrical wiring cable connector of claim 1, wherein said electrical wiring cable connector is constructed of materials that will last for 10 years or more under normal operating conditions and each of said male and female members that accepts a wiring cable group when installed further comprises a hollow threaded member to engage threads on the main body of said male or female member of said electrical wiring cable connector when said hollow threaded member is installed and tightened to cause splines of said main body of said member to be compressed and to grip a cable shield sleeve or a cable cable that is installed within said member seal.

5. The electrical wiring cable connector of claim 1, wherein said at least two connectable members as an electrical wiring cable connector pair that can be reversibly joined provide electrical termination for at least one wiring cable group within said electrical wiring cable connector pair and said electrical wiring cable connector pair that may be referred to individually as a male connector member and a female connector member.

6. The electrical wiring cable connector of claim 1, wherein said at least two connectable members as an electrical wiring cable connector pair that can be reversibly joined provide electrical termination for at least one wiring cable group within said electrical wiring cable connector pair and said electrical wiring cable connector pair that may be referred to individually as a male connector member and a female connector member.

7. The electrical cable connector of claim 6, wherein said female connection member further comprises an end cap and said member is the terminating member of said electrical wiring connector pair.

8. The electrical cable connector of claim 7, wherein said end cap comprises a structure for anchoring an assembly or disassembly tool.

9. The electrical cable connector of claim 6, wherein said male connection member further comprises an end cap and said member is the terminating member of said electrical wiring connector pair.

10. The electrical cable connector of claim 9, wherein said end cap comprises a structure for anchoring an assembly or disassembly tool.

11. The electrical cable connector according to claim 1, wherein individual wires of said wiring cables are terminated with crimp style wiring contacts having at least one locking tab that can be anchored within a cavity of at least one of the members for said electrical wiring connector pair.

12. The electrical cable connector according to claim 11, wherein said crimp style wiring contacts are located within at least double sleeving when installed within a connected electrical wiring connector pair.

13. The electrical cable connector according to claim 1, wherein said sealing member is an O-ring weather seal.

14. The electrical cable connector according to claim 13, wherein said sealing member provides an environmental barrier against water, sand, dust, airborne corrosives, and other similar environmental hazards.

15. The electrical cable connector according to claim 1, wherein electrical wiring is electrically isolated within said electrical cable connector to provide safe handling of the exterior of said electrical connector.

16. The electrical cable connector according to claim 1, wherein said male member comprises a plurality of lugs that can lodged within a plurality of lug receptor cavities on said female member and locked within said receptor cavities to reversibly attach and hold said electrical connector members together upon their assembly and to provide a means to disassemble said members.

17. The electrical cable connector according to claim 16, wherein said connector provides structures and means for quick and safe separation of male and female members of said electrical cable connector pair to disconnect electrical wiring by use of a separation tool that permits disconnection of internal wiring contacts of said electrical cable connector while leaving no exposed or protruding bare wires from said electrical cable connector.

18. A tool for quickly separating the male and female members of said electrical cable connector pair according to claim 1 with a single movement of the tool once said tool is engaged.

19. A method for reversibly connecting or reversibly disconnecting two wiring cable groups comprising the steps of installing each of said two wiring groups within either the male member or female member of said electrical cable connector of claim 1 and then connecting the two members or by utilizing at least one disconnection tool and separating said male and female members of said electrical cable connector.

20. A method for reversibly terminating or reversibly disconnecting a termination for a wiring cable group comprising the steps of installing a wiring cable group within either the male member or female member of said electrical cable connector of claim 1 and then connecting the two members or by utilizing at least one disconnection tool and separating said male and female members of said electrical cable connector to disconnect the termination of wiring.
